(19) United States
(12) Patent Application Publication
(10) Pub. No.: US 2013/0232061 A1
(43) Pub. Date: Sep. 5, 2013

(54) REDUCING UNSOLICITED TRAFFIC IN COMMUNICATION NETWORKS

(71) Applicant: CARMEL - HAIFA UNIVERSITY ECONOMIC CORPORATION LTD., Haifa (IL)

(72) Inventors: Shay GUERON, Haifa (IL); Ohad I. UNNA, North York (CA)

(73) Assignee: Carmel - Haifa University Economic Corporation Ltd, Haifa (IL)

(21) Appl. No.: 13/769,415

(22) Filed: Feb. 18, 2013

Related U.S. Application Data
(60) Provisional application No. 61/605,259, filed on Mar. 1, 2012.

(51) Int. Cl. G06Q 20/10

(52) U.S. Cl. CPC G06Q 20/10
USPC 705/39

(57) ABSTRACT

A computerized method of associating an economic transaction with messages being sent across a communication network. The method comprises providing a message to be sent from a sender to at least one intended recipient, constructing at least one transaction securely associating an economic value to be transferred from the sender to at least one intended recipient, associating between the transaction and the message, and transmitting the message from the sender to at least one intended recipient.

### RELATED APPLICATION

This application claims the benefit of priority under 35 USC §119(e) of U.S. Provisional Patent Application No. 61/605,259 filed Mar. 1, 2012, the contents of which are incorporated herein by reference in their entirety.

### BACKGROUND

The present invention, in some embodiments thereof, relates to traffic flow in communication networks and, more specifically, but not exclusively, to undesired and desired message control within communication networks.

The proliferation of unsolicited messages, also referred to as spam, has become a disturbance to internet users and businesses, as well as a burden on internet and telephony infrastructures. Spam communication can be disseminated in bulk to mass lists of recipients, cheaply and often anonymously. As such, unsolicited messaging remains economically viable because advertisers have little or no operating costs beyond the management of their mailing lists. It is also difficult to hold senders accountable for their mass mailings.

Existing approaches of mitigating spam require considerable involvement of recipients, for example their cooperation in identifying and reporting spam, or collaboration with legitimate senders. Other approaches include scanning and filtering messages according to pattern recognition techniques. These may result in unwanted filtering of messages sent from legitimate senders and commercial advertisers. Moreover, pattern recognition techniques can be circumvented by astute spammers over time.

Current anti-spam methodologies involving user interaction include, among others, avoiding the use of contact forms on the internet or disabling HTML rendering in e-mail. More centralized approaches include reputation services such as a sender policy framework or challenge-response systems for unknown senders. Such systems typically manage DNS blacklists of IP addresses of known spammers, known open relays, known proxy servers, compromised “zombie” spammers or the like.

### SUMMARY

According to some embodiments of the present invention, there is provided a computerized method of associating an economic transaction with messages being sent across a communication network. The method comprises providing a message to be sent from a sender to at least one intended recipient, constructing at least one transaction securely associating an economic value to be transferred from the sender to the at least one intended recipient, associating between the at least one transaction and the message, and transmitting the message from the sender to the at least one intended recipient.

Optionally, the method further comprises transmitting the at least one transaction to at least one clearing entity.

Optionally, the economic value is selected from a group consisting of monetary value, IP communication credit, and store credit.

More optionally, the economic value is determined according to attributes of the message.

More optionally, the attributes are selected from a group consisting of: message size, content type, sender's identity and recipient's identity.

Optionally, the economic transaction is assigned an economic value of zero.

More optionally, determining the economic value to be transferred from the sender to the at least one intended recipient comprises consulting with at least one reputation service regarding the integrity of the sender.

Optionally, the method further comprises construction of at least one offsetting transaction securely associating an offsetting economic value to be transferred from the at least one intended recipient to the sender, and associating between the at least one offsetting transaction and the message.

More optionally, the offsetting economic value of the at least one offsetting transaction is substantially equal to the economic value of the transaction.

Optionally, the method further comprises receiving at least one transaction confirmation from the at least one clearing entity and using the at least one transaction confirmation for construction of at least one collaborative correspondent lists.

More optionally, constructing the at least one transaction comprises consulting with the at least one collaborative correspondent lists.

More optionally, constructing the at least one offsetting transaction comprises consulting with the at least one collaborative correspondent lists.

Optionally, assigning the economic value to the at least one transaction comprises consulting with at least one reputation service regarding the integrity of the sender.

Optionally, constructing at least one transaction comprises digital authentication of the sender and the at least one intended recipient.

More optionally, the digital authentication uses Public Key Infrastructure for securing data exchange on networks.

According to some embodiments of the present invention, there is provided a system for associating an economic transaction to a message being sent across a communication network. The system comprises a processor, a transaction generation module which constructs at least one transaction associating an economic value to be transmitted from a sender to at least one recipient, an authentication module which securely associates the at least one transaction with the message, and a transmission module which transmits the message to the at least one recipient.

According to some embodiments of the present invention, there is provided a computerized method of crediting a recipient of messages being sent across a communication network. The method comprises receiving a message sent from a sender to an intended recipient, identifying an economic transaction associated with the message using a processor, debiting an account associated with the sender for an economic value specified in the economic transaction and crediting another account associated with the intended recipient for the economic value.

Optionally, the economic value is selected from a group consisting of monetary value, IP communication credit, and store credit.

Optionally, the method further comprises receiving from the intended recipient a user selection indicative of whether to retrieve the economic value from the account to the another account or not.

Optionally, the method further comprises automatically retrieving the economic value from the account to the other account if the sender is a member of a group consisting of: a social network friend, a contact in a book address, and a participant in previously held reciprocal correspondence.

According to some embodiments of the present invention, there is provided a computerized method of associating an economic transaction with voice calls being exchanged across a communication network. The method comprises providing a voice call initiation message to be sent from a sender to at least one intended recipient, constructing at least one call initiation transaction securely associating an economic value to be transferred from the sender to the at least one intended recipient, associating between the at least one call initiation transaction and at least one call initiation message, and transmitting the call initiation message from the sender to the at least one intended recipient.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE SEVERAL VIEWS OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a schematic illustration of the communication schema of associating monetary transactions with messages being sent and received across a communication network, according to some embodiments of the present invention;

FIG. 2 is a relational view of software and hardware components of a system for managing the association of monetary transactions with messages being sent and received across a communication network, according to some embodiments of the present invention;

FIG. 3 is a flowchart of a method for assigning a monetary value to a message sent to a recipient in a communication network, according to some embodiments of the present invention; and

FIG. 4 is a flowchart of a method for crediting recipients of messages being sent across a communication network, according to some embodiments of the present invention.

### DETAILED DESCRIPTION

The present invention, in some embodiments thereof, relates to traffic flow in communication networks and, more specifically, but not exclusively, to undesired message control within communication networks.

According to some embodiments of the present invention, there are provided methods and systems of debiting senders of electronic messages for the transmission of the electronic messages across a communication network and respectively crediting recipients thereof for the reception of the electronic messages. An economic transaction, such as but not limited to a monetary transaction is associated with every message sent. The economic transaction credits recipients for receiving electronic messages so that they either gain from receiving unsolicited correspondence or refund senders of desired correspondence, for example in reciprocal relationships. The methods and systems may reduce bulk commercial correspondence as senders are optionally charged for each and every recipient. As senders may be charged for sending unsolicited correspondence, the responsibility and burden for monitoring the economical value of such messages is on the senders. This represents a different paradigm from currently available spam filters, which are purchased and managed to monitor unsolicited correspondence at the recipient side. The methods and systems allow reducing recipient's need to use complex, expensive anti-spam tools and methods to filter out unsolicited mail.

In some embodiments, the economic transactions are embodied as secure micro-payments for messages sent across a communication network. Each micro-payment specifies a transaction specifying a monetary value or any other economic value such as store credit to be transmitted from a sender to a recipient by a clearing entity. The clearing entity serves as a trusted third party accountable for the economic aspect of the correspondence. Optionally, the clearing entity is based on the financial infrastructure of bank accounts and/or credit accounts. For example, any online payment service such as but not limited to PayPal™, optionally allowing for trusted anonymous correspondence without compromising the privacy of the participants such that further identification is voluntary. Additionally and alternatively, web mail systems or the like may serve as clearing entities providing depletable IP communication credit, which may be managed in a substantially similar manner to monetary credit.

Senders and receivers of messages may use a monetary transaction manager serving as a proxy to securely communicate with the trusted clearing entity using secure authentication protocols. Opening an account with the monetary transaction manager may not require any identification beyond that provided by a digital signature or a public key. Ownership of the account can be validated according to the ability to sign using a corresponding private key. Anonymity may be enhanced by senders opening multiple accounts, each with a corresponding digital certificate.

The monetary value of each transaction may vary, for example may have a rate of a regular postal stamp or Voice over IP (VOIP) communication, aligning the cost of sending messages over a communication network to that of sending a postcard through the post office. This alignment may push senders to consider their recipient lists, as the cost of sending messages or placing telemarketing calls may vary according to the collaboration of the recipient with the communication.

Transactions may be discarded, redeemed by recipients and/or refunded using one or more offsetting transaction when the sender is acknowledged by the recipient as a legitimate, collaborative correspondent. Notices of offsetting transactions made by recipients back to the senders may be used by the senders to identify collaborative recipients as target recipients for future correspondence which is likely to be cost free to the sender.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

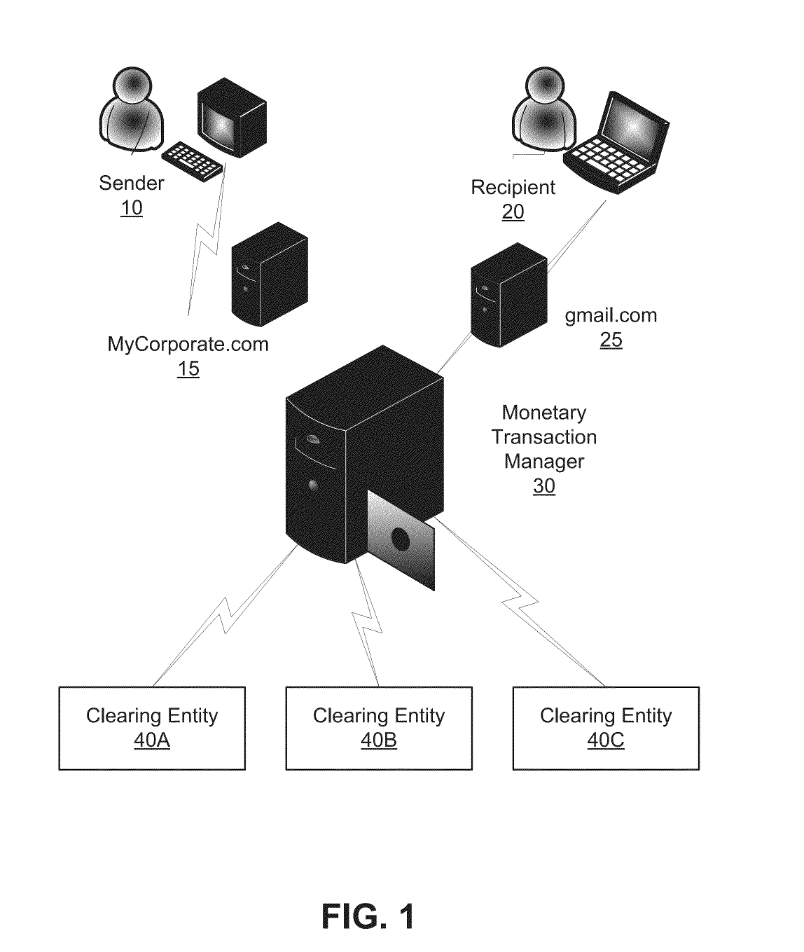

Reference is made to FIG. 1, which is a schematic illustration of the relationships between entities employing the systems and methods for associating monetary transactions with messages being sent and received across a communication network, according to some embodiments of the present invention.

The figure illustrates a sender's client terminal 10 behind a corporate mail server 15 and a recipient's client terminal 20 using a mail server 25 for transmitting and receiving e-mail messages.

Substantially similar entities can be used to disseminate other message types such as but not limited to mobile phone messages (“SMS”), phone calls over Global Systems for Mobile Communication (GSM), telemarketing calls which use Voice over IP (VOIP) as the communication protocol and platform, messages on internet forums or social networks or fax transmissions.

Client terminals 10 and 20 may represent personal computers, laptops, personal digital assistants, smartphones having advanced computing capabilities or any other client terminal configured to send and receive messages across a communication network. Optionally, these terminals may be placed behind a private telephony branch exchange or an organizational mail server as an endpoint for transmission and reception of messages. Contemporary basic phones may utilize GSM protocol security to rely on trusted telephony carriers for authentication, crediting, and debiting activities.

A server 30 serves as a monetary transaction manager. The monetary transaction manager 30 monitors messages transmitted between client terminals 10 and 20, associates monetary transactions with the messages, and communicates with a plurality of online payment services, referred to herein as clearing entities 40A, 40B and 40C. Clearing entities manage monetary transactions between accounts such as online banking accounts, credit accounts and PayPal™ accounts.

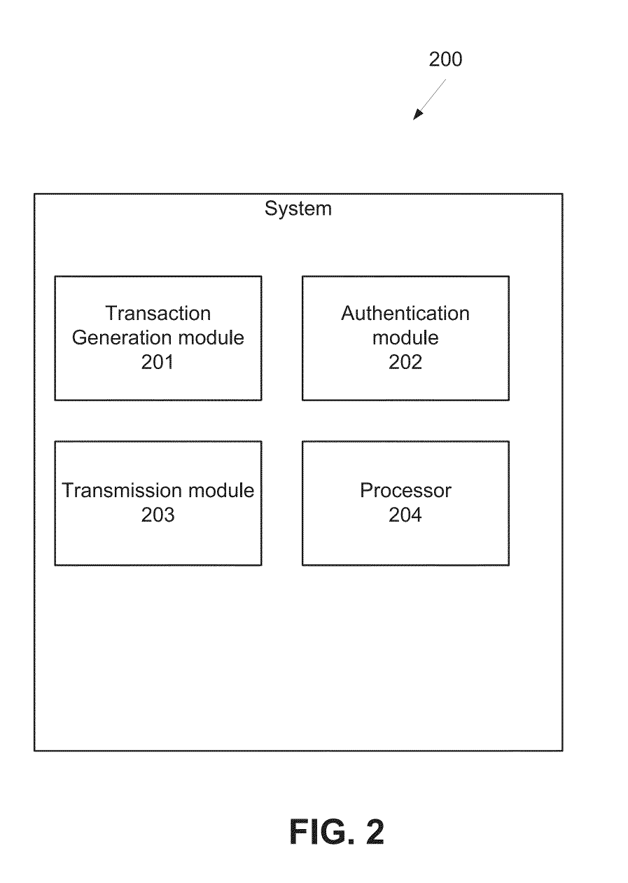

Reference is made to FIG. 2, which is a relational view of software and hardware components of a system 200 for managing the association of monetary transactions with messages being sent and received across a communication network, according to some embodiments of the present invention. The system 200 includes a transaction generation module 201, an authentication module 202, a transmission module 203, and a processor 204. For brevity, it should be noted that computing functions described herein may be performed using the processor 204.

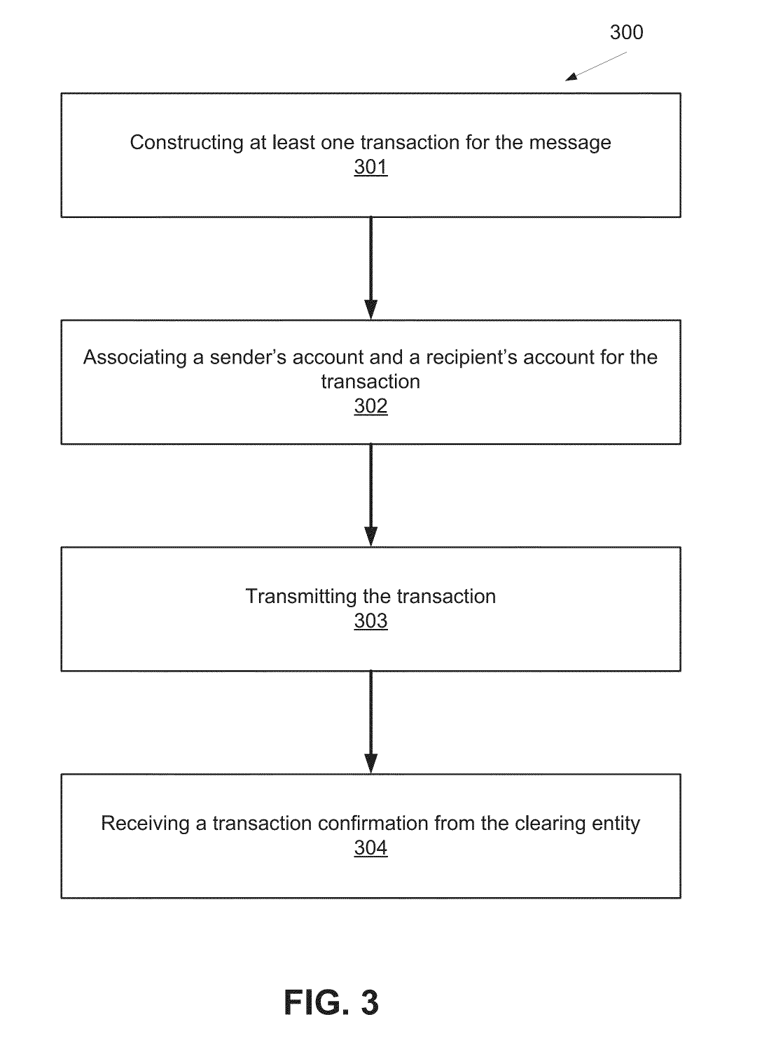

Reference is also made to FIG. 3, which is a flowchart of a method 300 for assigning a monetary transaction to a message sent across a communication network, according to some embodiments of the present invention. Optionally, the method provides for a cryptographically secure protocol to accompany messages with transactions. Each transaction comprises a monetary value to be transferred by a clearing entity from a sender to a recipient.

As shown in numeral 301 in FIG. 3, when a message is transmitted by a sender registered for the service, the message is sent to and monitored by system 200, also referred to herein as a monetary transaction manager. At least one transaction is constructed as a message stamp, for example using the transaction generation module 201 of FIG. 2. The transaction is a secure note of payment, typically having a relatively low monetary value such as the cost of a postal stamp, configured to be redeemed by an intended recipient.

Typically, one transaction is constructed for every recipient of the message, such that the number of transactions per message is substantially equal to the number of recipients on the recipients' list. In multi-recipient correspondence, multiple transactions are each associated with one of the intended recipients of the message.

In some embodiments, the monetary value specified for each transaction is fixed, for example the value of a postal stamp. In other embodiments, the monetary value specified for each transaction may vary, for example according to message attributes such as but not limited to message size, content type, the sender's or the recipient's identity, or the like. For example, a reputation service may be contacted to identify legitimate senders, so that the monetary value assigned to a transaction associated with a message sent by a sender with high integrity is relatively low compared to the value assigned to other senders. Additionally and alternatively, the monetary value can be determined according to environmental variables which are not message specific, for example and without limitation time of day in which the message is transmitted or governmental regulations regarding the sender's integrity as a non-spammer. Government regulation may stipulate that some officially recognized entities are exempt from payment. In such cases, a payment with an economic value of zero may be affixed to messages, such that part or all of the authentication procedure takes place regardless of the economic value.

Each transaction may include a return correspondence address of the sender, to which an offsetting transaction may be sent by the intended recipient of the original transaction. Typically, this offsetting payment would be made by message recipients to senders they perceive as legitimate.

Transactions are optionally created by contacting a clearing entity holding a credit account for the sender. Additionally and alternatively, in some embodiments the monetary transaction manager may serve as an online store for purchasing monetary credit by senders. Purchasing monetary credit by senders may be performed by the monetary transaction manager or via a trusted third-party, such as but not limited to a financial institution. Purchasing other forms of economic values, for example airtime for placing VOIP calls may involve contacting a local ISP or VOIP servicing provider. As shown in numeral 302, a unique sender account and a unique recipient account are associated with the transaction, for example using the authentication module 202 of FIG. 2. The transaction and the message are associated such that the unique identity of the sender and the recipient are compliant with the respective identities of the payer's and the payee's account holders as specified on the micro-payment.

The unique sender can be identified against a clearing entity for example using Public Key Infrastructure for securing data exchange on networks by providing each party with digital certificates that validate their authenticity against a trusted certificate authority, ensuring non-repudiation of the sender's commitment to the transaction, as well as avoidance of “Man in the middle” attacks where a fraudulent message is created with a purloined payment derived from the original message. Authentication using digital certificates can also be used to hide the sender's identity from the recipient, but not from the monetary transaction manager, allowing a central authority to regulate messages associated with transactions without compromising the identity of the sender if he does not wish to be identified by the recipient. In some embodiments, senders may open anonymous credit accounts, hiding their identities from recipients and any central authorities. Such accounts may be funded exclusively by credit earned through reception of unsolicited messages.

Communication systems such as but not limited to webmail services may recognize communication accounts used for spamming according to patterns of indiscriminate bulk message transmission to multiple recipients. Communication accounts used for spam mainly send and rarely receive messages, whereas recipient accounts have substantially balanced message transmission and reception patterns. Circumvention of spam account identification may include automation of account opening procedures by spammers, such that multiple accounts from which bulk communication is sent are available to the sender. Such circumvention may be prevented by communication systems, for example and without limitation by implementing challenge-response tests such as CAPTCHA in account opening procedures.

In some embodiments, the message along with its respective one or more transactions is transmitted to the intended recipients as shown in numeral 303, for example by the transmission module 203 in FIG. 1. In other embodiments, the one or more transactions are sent back to the transmission endpoint, for example to a corporate private branch exchange or a mail exchange server. The transmission endpoint transmits the message associated with the one or more transaction to the intended recipients. Once the message is transmitted, the sender's account is charged. A payment request is submitted to the clearing entity, specifying the payer's account and the payee's account. A transaction confirmation may be received from the clearing entity as shown in numeral 304.

In some embodiments, the sender may receive a confirmation when a transaction is exercised by a recipient. Additionally and alternatively, the sender may receive a confirmation notice when an offsetting transaction is made by a recipient back to the sender. Confirmation notices may be received from the monetary transaction manager, associating the transaction or the offsetting transaction with a specific message and/or a specific recipient. The sender may use confirmation notices as testaments of collaboration to construct lists of collaborative and non-collaborative correspondents for future reference.

When a message is received it can be discarded or read by the recipient.

According to some embodiments of the present invention, where the sender does not wish to maintain anonymity, public key algorithms are used for authentication which do not require the intervention of a trusted third party. For example, the transaction may include the recipient's identification in the form of a public key known to the sender, a payment amount, a sender's account number, and a one-time use serial number. In order to exercise the transaction, the recipient opens the signed transaction with his private key. Similarly, an offsetting transaction may be constructed and signed along with the original sender's public key.

Optionally, the clearing entity verifies the signature of the payer, charges his account with the payment, and credits the account of the payee, returning a message attesting that the transaction was successful. The transaction can be considered successful by the recipient after the bank's signed message is authenticated against the bank's public key.

In some embodiments, the transaction is automatically redeemed when a message is received by the intended recipient. An offsetting payment may be sent by the recipient to the legitimate senders upon the will of the recipient. For example, such an offsetting payment may include an equal value payment to the sender, using a similar payment format. The sender may receive a confirmation regarding the offsetting payment. The sender's identity can be verified against a whitelist of collaborative, legitimate correspondents. The monetary transaction manager may manage global and user-specific blacklists of senders. These lists may be used to assign higher monetary values to transactions associated with messages where the sender is blacklisted. User-specific lists may be maintained according to user preferences. For example, a user may configure settings according to a social network account, for example such that immediate contacts are automatically refunded with an offsetting payment.

Global lists may be created according to transaction history serving as feedback received from a plurality of recipients about senders. For example, a history of recipients' readiness to generate offsetting micro-payments to a sender may increase the sender's fidelity such that he enters a white list of non-spammers.

In cases where the sender's identity is not found or blacklisted, the recipient may be presented with a choice, possibly a preset default, of whether to return a receipt with an offsetting payment, read the message and collect the proceeds, or ignore the message and collect the proceeds. This may be performed manually by the user, automatically by a messaging client, and/or an intermediate module, such that a receipt does not attest to whether the message was in fact processed or read.

The monetary transaction manager may monitor redeemed payments, using them as testaments indicating collaboration of the intended recipient with the respective sender. This data may be used to update and filter recipient lists for example and without limitation according to the likelihood of the message being accepted by the recipient. In some embodiments, the monetary transaction manager may maintain full identification records for account holders, allowing for account audits and preventing the transaction manager from becoming a vehicle for constant one-way currency flow for individuals, businesses and commercial advertisers.

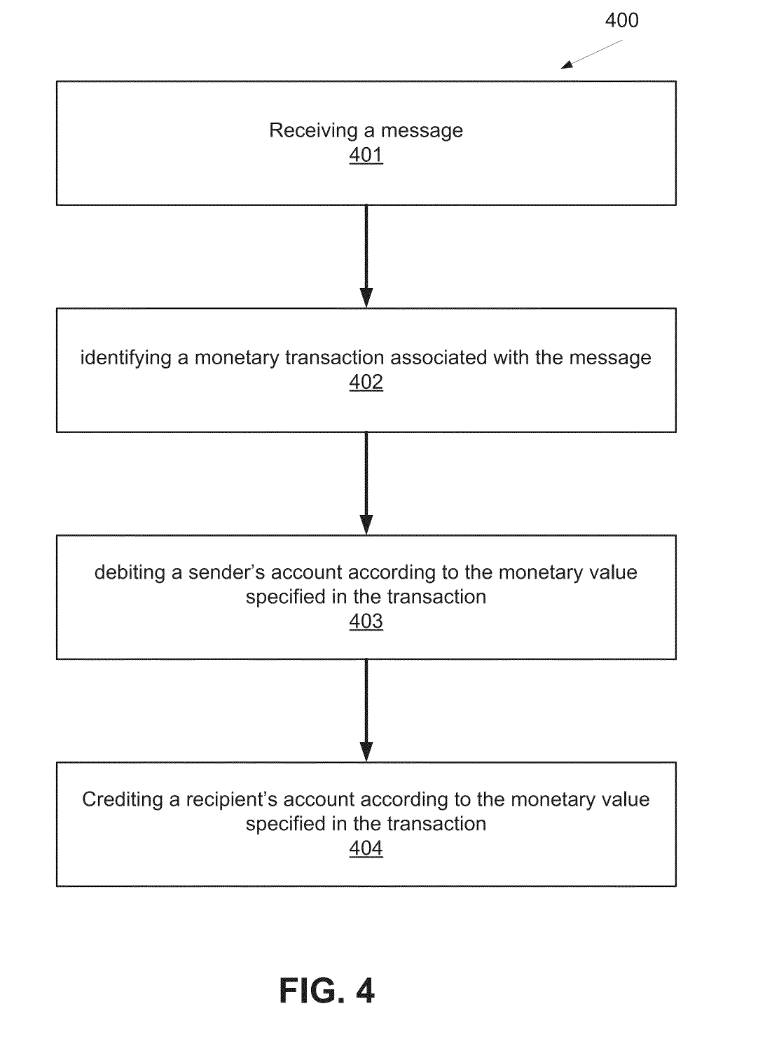

Reference is made to FIG. 4, which is a flowchart of a method 400 for crediting recipients of messages being sent across a communication network, according to some embodiments of the present invention. The method comprises receiving a message sent across a communication network from a sender to an intended recipient 401, and using a processor to identify a monetary transaction associated with the message 402. According to the monetary value specified in the transaction, an account associated with the sender is debited 403. Similarly, another account associated with the intended recipient is credited for a similar amount 404.

In some embodiments, debiting the sender 403 and crediting the recipient 404 is performed automatically without receiving further instructions from the recipient. In other embodiments, carrying out the monetary transaction is according to a user selection indicative of whether the monetary value should or should not be retrieved. In some embodiments, the transaction is automatically redeemed with an offsetting transaction, for example according to the identity of the sender. Embodiments of the systems and methods may consult with social networks, address books, and historic messaging records which may be used as testaments of reciprocal correspondence relationships between the sender and the recipient, using these testaments to determine whether the transaction should be automatically redeemed with an offsetting transaction.

Embodiments of the systems and methods may serve to reduce bulk voice messaging using relatively inexpensive communication network platforms, for example and without limitation telemarketing calls using VOIP. Calling parties acting as senders may purchase economic values from VOIP telephony providers. Economic values may be in the form of monetary payments, VOIP calling credit for placing calls, or the like. In such embodiments, an economic call initiation transaction may be associated with every call initiation to a called party acting as the recipient of the call. Multiple call rejections by recipients may indicate that the calling party initiating such calls is spammer of unsolicited voice communication. Acceptance of a call by a recipient may serve as an indication of a reciprocate relationship between the calling party and the called party, and an offsetting transaction of substantially similar economic value to that of the call initiation transaction may be sent back from the recipient to the sender.

Embodiments of the systems and methods may be implemented as a messaging platform, an add-on to an existing messaging platforms, and/or as a software as a service (SaaS) which provides services for users via client terminals.

Embodiments of the systems and methods may comprise a signing device for signing appropriately formatted payment messages with an internally stored private key. The device may be small in size, for example such as a USB stick. The device comprises the ability to output its public key and a revocation code which may be sent to a clearing entity by the device's owner in case of loss or theft of the device. Typically, once initialized, the stick is not re-programmable, such that it is immune from virus attacks.

The signing device may comprise for example, a 10 character display, a signature button and a cancellation button. Upon construction of a micropayment for a message, the message may be sent to the device. Once received, if formatted as a micropayment, the payee and the amount are displayed on the stick's display. The device owner can press the signature button, and sign the message. The stick may ignore massages which are not properly formatted micropayments. Such a signing device may be used as a security measure to ensure that all signatures are handled in person by a valid user. The signing device may be configured during initialization to refuse signing payments above a preset threshold.

Optionally, the device could generate a nonce, and sign the micro-payment concatenated with this nonce, so that the signatures on identical messages would generate a unique message each time.

Tying a monetary transaction to every message sent across a communication network makes message transmission economically viable only when such messages have a reasonable probability of being tolerated by the recipient. Unsolicited messages will not only be rejected and ignored by the recipient, but also costly to the sender, and beneficial to the recipient.

While the most widely recognized form of unsolicited bulk messages sent indiscriminately relates to e-mail messaging, embodiments of the systems and methods apply to other media such as instant messaging, newsgroups, blogs, wikis, mobile phone messaging (“SMS”), Internet forums, junk fax transmissions, social networking, online classified advertising, television advertising or the like. The system and methods following this protocol may be integrated into communication networks such as the internet, or any subset of a communication networks using Private Branch Exchanges, Internet Service Providers, cellular phone carriers or the like.

The methods as described above are used in the fabrication of integrated circuit chips.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It is expected that during the life of a patent maturing from this application many relevant systems and methods will be developed and the scope of the terms a processor and a traffic reduction entity is intended to include all such new technologies a priori.

As used herein the term “about” refers to ±10%.

The terms “comprises”, “comprising”, “includes”, “including”, “having” and their conjugates mean “including but not limited to”. This term encompasses the terms “consisting of” and “consisting essentially of”.

The phrase “consisting essentially of” means that the composition or method may include additional ingredients and/or steps, but only if the additional ingredients and/or steps do not materially alter the basic and novel characteristics of the claimed composition or method.

As used herein, the singular form “a”, “an” and “the” include plural references unless the context clearly dictates otherwise. For example, the term “a compound” or “at least one compound” may include a plurality of compounds, including mixtures thereof.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided according to some embodiments of the present invention, and not provided in other embodiments”. Any particular embodiment of the invention may include a plurality of “optional” features unless such features conflict.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

What is claimed is:

1. A computerized method of associating an economic transaction with messages being sent across a communication network, the method comprising:
providing a message to be sent from a sender to at least one intended recipient;
constructing at least one transaction securely associating an economic value to be transferred from said sender to said at least one intended recipient;
associating between said at least one transaction and said message; and
transmitting said message from said sender to said at least one intended recipient.

2. The computerized method of claim 1, further comprising transmitting said at least one transaction to at least one clearing entity.

3. The computerized method of claim 1, wherein said economic value is selected from a group consisting of monetary value, IP communication credit, and store credit.

4. The computerized method of claim 1, wherein said economic value is determined according to attributes of said message.

5. The computerized method of claim 4, wherein said attributes are selected from a group consisting of: message size, content type, sender's identity and recipient's identity.

6. The computerized method of claim 1, wherein said economic transaction is assigned an economic value of zero.

7. The computerized method of claim 1, determining said economic value to be transferred from said sender to said at least one intended recipient comprises consulting with at least one reputation service regarding the integrity of said sender.

8. The computerized method of claim 1, further comprising construction of at least one offsetting transaction securely associating an offsetting economic value to be transferred from said at least one intended recipient to said sender, and associating between said at least one offsetting transaction and said message.

9. The computerized method of claim 8, wherein said offsetting economic value of said at least one offsetting transaction is substantially equal to said economic value of said transaction.

10. The computerized method of claim 2, further comprising receiving at least one transaction confirmation from said at least one clearing entity and using said at least one transaction confirmation for construction of at least one collaborative correspondent lists.

11. The computerized method of claim 10, wherein constructing said at least one transaction comprises consulting with said at least one collaborative correspondent lists.

12. The computerized method of claim 10, wherein constructing said at least one offsetting transaction comprises consulting with said at least one collaborative correspondent lists.

13. The computerized method of claim 1, wherein assigning said economic value to said at least one transaction comprises consulting with at least one reputation service regarding the integrity of said sender.

14. The computerized method of claim 1, wherein said constructing at least one transaction comprises digital authentication of said sender and said at least one intended recipient.

15. The method of claim 14, wherein said digital authentication uses Public Key Infrastructure for securing data exchange on networks.

16. A system for associating an economic transaction to a message being sent across a communication network, the system comprising:
a processor;
a transaction generation module which constructs at least one transaction associating an economic value to be transmitted from a sender to at least one recipient;
an authentication module which securely associates said at least one transaction with said message; and
a transmission module which transmits said message to said at least one recipient.

17. A computerized method of crediting a recipient of messages being sent across a communication network, the method comprising:
receiving a message sent from a sender to an intended recipient;
identifying an economic transaction associated with said message using a processor;
debiting an account associated with said sender for an economic value specified in said economic transaction; and
crediting another account associated with said intended recipient for said economic value.

18. The computerized method of claim 17, wherein said economic value is selected from a group consisting of monetary value, IP communication credit, and store credit.

19. The computerized method of claim 17, further comprising receiving from said intended recipient a user selection indicative of whether to retrieve said economic value from said account to said another account or not.

20. The computerized method of claim 19, automatically retrieving said economic value from said account to said another account if said sender is a member of a group consisting of: a social network friend, a contact in a book address, and a participant in previously held reciprocal correspondence.

21. A computerized method of associating an economic transaction with voice calls being exchanged across a communication network, the method comprising:
providing a voice call initiation message to be sent from a sender to at least one intended recipient;
constructing at least one call initiation transaction securely associating an economic value to be transferred from said sender to said at least one intended recipient;
associating between said at least one call initiation transaction and at least one call initiation message; and
transmitting said call initiation message from said sender to said at least one intended recipient.
